(19) United States
(12) Patent Application Publication
(10) Pub. No.: US 2018/0230316 A1
(43) Pub. Date: Aug. 16, 2018

(54) ANTI-REFLECTIVE FILM (AS AMENDED)

(71) Applicant: LG CHEM, LTD., Seoul (KR)

(72) Inventors: Boo Kyung KIM, Daejeon (KR); Yeong Rae CHANG, Daejeon (KR); Dong Hyun KIM, Daejeon (KR); Hyun Kyung YOON, Daejeon (KR); Seok Hoon JANG, Daejeon (KR); Yu Ra LEE, Daejeon (KR); Jin Seok BYUN, Daejeon (KR)

(21) Appl. No.: 15/750,801

(22) PCT Filed: Mar. 10, 2017
(86) PCT No.: PCT/KR2017/002640

§ 371 Date: Feb. 6, 2018

(30) Foreign Application Priority Data
Mar. 14, 2016 (KR) 10-2016-0030393
Mar. 9, 2017 (KR) 10-2017-0030173

(51) Int. Cl. C09D 5/00; C09D 151/00; C09D 5/16; G02B 1/14; G02B 1/11

(52) U.S. Cl. CPC C09D 5/006; C09D 151/003; C09D 5/1675; C08K 3/36; G02B 1/11; C08K 2201/003; G02B 1/14

(57) ABSTRACT

The present invention relates to an anti-reflective film comprising: a hard coating layer and a low refractive layer which comprises a binder resin comprising a cross-linked polymer of a photopolymerizable compound, two or more kinds of fluorine-containing compounds comprising photoreactive functional groups, and polysilsesquioxane substituted by one or more reactive functional groups; and inorganic fine particles dispersed in the binder resin.

### TECHNICAL FIELD

### Cross-Reference to Related Application(s)

This application claims the benefit of Korean Patent Application No. 10-2016-0030393 filed on Mar. 14, 2016 and Korean Patent Application No. 10-2017-0030173 filed on Mar. 9, 2017 with the Korean Intellectual Property Office, the disclosures of which are herein incorporated by reference in their entirety.

The present invention relates to an anti-reflective film, and more specifically, to an anti-reflective film that has low reflectance and high light transmittance, that can simultaneously realize high scratch resistance and anti-fouling properties, and that can increase screen sharpness of a display device.

### BACKGROUND OF ART

In general, in flat panel display devices such as a PDP, an LCD, etc., an anti-reflective film is installed so as to minimize reflection of incident light from the outside.

Methods for minimizing the reflection of light include a method of dispersing a filler such as fine inorganic particles, etc. in a resin, coating it on a substrate film, and forming unevenness (anti-glare: AG coating), a method of using light interference by forming multiple layers having different refractive indexes on a substrate film (anti-reflective; AR coating), a method of using them together, etc.

Among them, in the case of AG coating, although the absolute amount of reflected light is equivalent to that of common hard coatings, a low reflection effect can be obtained by reducing the amount of light entering the eyes using light scattering through unevenness. However, since the AG coating has lowered screen sharpness due to the surface unevenness, recently, many studies are being conducted on AR coating.

As films using the AR coating, those having a multi-layered structure in which a hard coating layer (high refractive index layer), a low reflective coating layer, etc. are stacked on a substrate film are being commercialized. However, since the method of forming multiple layers conducts individual processes for forming each layer, it has a disadvantage in terms of lowered scratch resistance due to weak interlayer adhesion (interface adhesion).

Further, previously, in order to improve scratch resistance of the low refractive layer included in the anti-reflective film, a method of adding various particles of a nanometer size (for example, silica, alumina, zeolite, etc.) was mainly attempted. However, when nanometer-sized particles are used, it is difficult to simultaneously increase scratch resistance while lowering the reflectance of the low refractive layer, and due to the nanometer-sized particles, the anti-fouling property of the surface of the low refractive layer is significantly deteriorated.

Accordingly, in order to reduce the absolute reflection amount of incident light from the outside and improve the anti-fouling property as well as scratch resistance of the surface, many studies are being conducted, but the resulting property improvement degree is unsatisfactory.

### DETAILED DESCRIPTION OF THE INVENTION

### Technical Problem

It is an object of the present invention to provide an anti-reflective film that has low reflectance and high light transmittance, that can simultaneously realize high scratch resistance and anti-fouling properties, and that can increase screen sharpness of a display device.

### Technical Solution

There is provided an anti-reflective film comprising: a hard coating layer and a low refractive layer which comprises a binder resin comprising a cross-linked polymer of a photopolymerizable compound, two or more kinds of fluorine-containing compounds comprising photoreactive functional groups, and polysilsesquioxane substituted by one or more reactive functional groups; and inorganic fine particles dispersed in the binder resin.

Hereinafter, an anti-reflective film according to specific embodiments of the invention will be explained in detail.

In the present specification, a photopolymerizable compound commonly designates a compound that causes a polymerization reaction if light, for example visible rays or ultraviolet rays, is irradiated thereto.

Further, a fluorine-containing compound means a compound including at least one fluorine atom in the compound.

In addition, “(meth)acryl” includes both acryl and methacryl.

The term “(co)polymer” includes both copolymer and homopolymer.

Additionally, silica hollow particles are silica particles derived from a silicon compound or an organosilicon compound, wherein an empty space exists on the surface and/or inside of the silica particles.

According to one embodiment of the present invention, there is provided an anti-reflective film comprising: a hard coating layer and a low refractive layer which comprises a binder resin comprising a cross-linked polymer of a photopolymerizable compound, two or more kinds of fluorine-containing compounds comprising photoreactive functional groups, and polysilsesquioxane substituted by one or more reactive functional groups; and inorganic fine particles dispersed in the binder resin.

The present inventors performed studies on a low refractive layer and an anti-reflective film, confirmed through experiments that an anti-reflective film including a low refractive layer formed from a photocurable coating composition including a photopolymerizable compound, two or more kinds of fluorine-containing compounds including photoreactive functional groups and polysilsesquioxane substituted by one or more reactive functional groups can realize lower reflectance and higher light transmittance, can improve abrasion resistance or scratch resistance, and can simultaneously secure excellent an anti-fouling property to external pollutants, and completed the present invention.

Since the anti-reflective film can increase screen sharpness of a display device and has excellent scratch resistance and anti-fouling properties, it can be applied for a manufacturing process of a display device or a polarizing plate without specific limitations.

Previously, in order to improve scratch resistance of a low refractive layer included in an anti-reflective film, a method of adding various particles of a nanometer size (for example silica, alumina, zeolite, etc.) was mainly attempted. However, when nanometer-sized particles are used, it was difficult to increase scratch resistance while lowering the reflectance of a low refractive layer, and due to the nanometer-sized particles, the anti-fouling property of the surface of the low refractive layer was significantly deteriorated.

To the contrary, in the low refractive layer included in the anti-reflective film of one embodiment, two or more kinds of fluorine-containing compounds including photoreactive functional groups exist while being cross-linked with other components, and thus the anti-reflective film may have lower reflectance and improved light transmittance, and can secure high anti-fouling to external pollutants while improving mechanical properties such as scratch resistance, etc.

Specifically, due to the properties of the fluorine atom included in the fluorine-containing compound including a photoreactive functional group, the interaction energy of the low refractive layer and the anti-reflective film with liquids or organic materials may be lowered, and thus the amount of pollutants transferred to the low refractive layer and the anti-reflective film can be significantly reduced, the transferred pollutants can be prevented from remaining on the surface, and the pollutant itself can be easily removed.

Further, in the process of forming the low refractive layer and the anti-reflective film, the reactive functional groups included in the fluorine-containing compounds including photoreactive functional groups are as crosslinked, thereby increasing physical durability, scratch resistance, and thermal stability of the low refractive layer and the anti-reflective film.

Particularly, by using two or more kinds of the fluorine-containing compounds including photoreactive functional groups, a higher synergistic effect can be obtained compared to the case of using one kind of fluorine-containing compound including a photoreactive functional group, and specifically, more improved surface properties such as anti-fouling and slip properties, etc., can be realized while securing higher physical durability and scratch resistance, and in the process of forming the low refractive layer and the anti-reflective film, a large area coating is easy to apply, thereby increasing productivity and efficiency of the manufacturing process of a final product.

The anti-reflective film of the embodiment exhibits relatively low reflectance and total haze, and thus can realize high light transmittance and excellent optical properties. Specifically, the total haze of the anti-reflective film may be 0.45% or less, 0.05% to 0.45% or less, 0.25% or less, or 0.10% to 0.25% or less. And, the anti-reflective film may have mean reflectance or 2.0% or less, 1.5% or less, 1.0% or less, 1.0% to 0.10%, 0.40% to 0.80%, or 0.54% to 0.69% in the visible light wavelength region of 380 nm to 780 nm.

The two or more kinds of fluorine-containing compounds including photoreactive functional groups may be classified according to the fluorine content range, and specifically, the two or more kinds of fluorine-containing compounds including photoreactive functional groups may have different fluorine content ranges according to the kind.

Due to the properties arising from the fluorine-containing compound having a higher fluorine content among the two or more kinds of fluorine-containing compounds including photoreactive functional groups, the low refractive layer and anti-reflective film may have a more improved anti-fouling property while securing lower reflectance.

In addition, the fluorine-containing compound having a lower fluorine content among the two or more kinds of fluorine-containing compounds including photoreactive functional groups may further increase compatibility with other components included in the low refractive layer, and furthermore, allows the low refractive layer and anti-reflective film to have higher physical durability and scratch resistance and have a homogeneous surface property and a high surface slip property as well as an improved anti-fouling property.

More specifically, the two or more kinds of fluorine-containing compounds including photoreactive functional groups may be divided on the basis of a fluorine content of 25 wt %. The content of fluorine included in each fluorine-containing compound including a photoreactive functional group can be confirmed through commonly known analysis methods, for example, IC [ion chromatography] analysis.

For example, the two or more kinds of fluorine-containing compounds including photoreactive functional groups may include a first fluorine-containing compound including a photoreactive functional group and including 25 wt % to 60 wt % of fluorine.

Further, the two or more kinds of fluorine-containing compounds including photoreactive functional groups may include a second fluorine-containing compound including a photoreactive functional group and including fluorine in a content of 1 wt % or more and less than 25 wt %.

As the low refractive layer includes 1) a first fluorine-containing compound including a photoreactive functional group and including 25 wt % to 60 wt % of fluorine, and 2) a second fluorine compound including a photoreactive functional group and including fluorine in the content of 1 wt % or more and less than 25 wt %, more improved surface properties such as an anti-fouling property and a slip property, etc. can be realized while securing higher physical durability and scratch resistance compared to the case of using one kind of fluorine-containing compound including a photoreactive functional group.

Specifically, due to the first fluorine-containing compound having a higher fluorine content, the low refractive layer and the anti-reflective film may have a more improved anti-fouling property while securing lower reflectance, and due to the second fluorine-containing compound having a lower fluorine content, the low refractive layer and the anti-reflective film may have higher physical durability and scratch resistance, and may have a homogeneous surface property and a high slip property as well as an improved anti-fouling property.

The fluorine content difference between the first fluorine-containing compound and the second fluorine-containing compound may be 5 wt % or more. As the fluorine content difference between the first fluorine-containing compound and the second fluorine-containing compound is 5 wt % or more, or 10 wt % or more, the effect resulting from each of the first fluorine-containing compound and the second fluorine-containing compound may be more increased, and thus the synergistic effect resulting from the use of the first fluorine-containing compound and the second fluorine-containing compound together may also be increased.

The terms first and second are intended to specify constructional elements referred to, but the order or importance, etc. is not limited thereby.

Although the weight ratio of the first fluorine-containing compound and the second fluorine-containing compound is not specifically limited, the weight ratio of the second fluorine-containing compound to the first fluorine-containing compound may be 0.01 to 0.5, and preferably 0.01 to 0.4, so that the low refractive layer and the anti-reflective film may have homogeneous surface properties as well as more improved scratch resistance and anti-fouling properties.

In each of the two or more kinds of fluorine-containing compounds including photoreactive functional groups, one or more photoreactive functional groups may be included or substituted, and the term “photoreactive functional group” means a functional group capable of participating in a polymerization reaction by the irradiation of light, for example, irradiation of visible light or UV. The photoreactive functional group may include various functional groups known to be capable of participating in a polymerization reaction by the irradiation of light, and specific examples thereof may include a (meth)acrylate group, an epoxide group, a vinyl group, and a thiol group.

The two or more kinds of fluorine-containing compounds including photoreactive functional groups may respectively have a weight average molecular weight (in terms of polystyrene measured by GPC) of 2000 to 200,000, and preferably 5000 to 100,000.

If the weight average molecular weight of the fluorine-containing compounds including photoreactive functional groups is too small, the fluorine-containing compounds may not be uniformly and effectively arranged on the surface of the low refractive layer and be positioned inside, and thus the anti-fouling property of the low refractive layer and the anti-reflective film may be deteriorated and the crosslinking density inside the low refractive layer and anti-reflective film may be lowered, thus deteriorating mechanical properties such as total strength or scratch resistance, etc.

Further, if the weight average molecular weight of the fluorine-containing compounds including photoreactive functional groups is too high, the haze of the low refractive layer and the anti-reflective film may increase or the light transmittance may be lowered, and the strength of the low refractive layer and anti-reflective film may also be deteriorated.

Specifically, the fluorine-containing compounds including photoreactive functional groups may include one or more selected from the group consisting of: i) aliphatic compounds or alicyclic compounds substituted by one or more photoreactive functional groups, in which at least one carbon is substituted by one or more fluorine atoms; ii) heteroaliphatic compounds or heteroalicyclic compounds substituted by one or more photoreactive functional groups, in which at least one hydrogen is substituted by fluorine, and at least one carbon is substituted by silicon; iii) a polydialkyl siloxane-based polymer (for example, a polydimethyl siloxane-based polymer) substituted by one or more photoreactive functional groups, in which at least one silicon atom is substituted by one or more fluorine atoms; iv) polyether compounds substituted by one or more photoreactive functional groups, in which at least one hydrogen is substituted by fluorine, and mixtures or copolymers of two or more of i) to iv).

The binder resin included in the low refractive layer may include a cross-linked polymer of a photopolymerizable compound and two or more kinds of fluorine-containing compounds including photoreactive functional groups.

The cross-linked polymer may include, based on 100 parts by weight of the parts derived from the photopolymerizable compound, 20 to 300 parts by weight of the parts derived from the two or more kinds of fluorine-containing compounds including photoreactive functional groups. The content of the two or more kinds of fluorine-containing compounds including photoreactive functional groups with respect to the photopolymerizable compound is based on the total content of the two or more kinds of fluorine-containing compounds including photoreactive functional groups.

If the two or more kinds of fluorine-containing compounds including photoreactive functional groups are excessively added compared to the photopolymerizable compound, the low refractive layer may not have sufficient durability or scratch resistance. In addition, if the content of the two or more kinds of fluorine-containing compounds including photoreactive functional groups is too small compared to the photopolymerizable compound, the low refractive layer may not have sufficient mechanical properties such as anti-fouling property or scratch resistance, etc.

The fluorine-containing compound including a photoreactive functional group may further include silicon or a silicon-containing compound. That is, the fluorine-containing compound including a photoreactive functional group may optionally contain silicon or a silicon-containing compound inside, and specifically, the content of silicon in the fluorine-containing compound including a photoreactive functional group may be 0.1 wt % to 20 wt %.

The content of silicon or a silicon-containing compound respectively included in the fluorine-containing compound including a photoreactive functional group can be confirmed through commonly known analysis methods, for example ICP [inductively coupled plasma] analysis.

The silicon included in the fluorine-containing compound including a photoreactive functional group may increase compatibility with other components included in the photocurable coating composition, and thus may prevent the generation of haze in the finally prepared low refractive layer, thereby increasing transparency, and furthermore, may improve the slip property of the surface of the finally prepared low refractive layer or anti-reflective film, thereby increasing scratch resistance.

Meanwhile, if the content of silicon in the fluorine-containing compound including a photoreactive functional group becomes too high, the low refractive layer or anti-reflective film may not have sufficient light transmittance or anti-reflective performance, and the anti-fouling property of the surface may be deteriorated.

Meanwhile, as explained above, the binder resin included in the low refractive layer includes a cross-linked polymer of a photopolymerizable compound, two or more kinds of fluorine-containing compounds including photoreactive functional groups, and polysilsesquioxane substituted by one or more reactive functional groups.

More specifically, the photocurable composition for forming a low refractive layer may include polysilsesquioxane substituted by one or more reactive functional groups, in addition to the above-explained photopolymerizable compound, and two or more kinds of fluorine-containing compounds including photoreactive functional groups.

The polysilsesquioxane substituted by one or more reactive functional groups has reactive functional groups on the surface, and thus may increase mechanical properties of the low refractive layer, for example, scratch resistance, and unlike the case wherein previously known fine particles such as silica, alumina, zeolite, etc. are used, may improve alkali resistance of the low refractive layer, and improve mean reflectance or appearance properties such as a color, etc.

The polysilsesquioxane may be represented by (RSiO_{1.5})ₙ (wherein n is 4 to 30 or 8 to 20), and may have various structures such as random, ladder, cage, partial cage, etc. Preferably, in order to increase the properties and qualities of the low refractive layer and anti-reflective film, polyhedral oligomeric silsesquioxane that is substituted by one or more reactive functional groups and has a cage structure may be used as the polysilsesquioxane substituted by one or more reactive functional groups.

More preferably, the polyhedral oligomeric silsesquioxane that is substituted by one or more reactive functional groups and has a cage structure may include 8 to 20 silicon atoms in the molecule.

In the polyhedral oligomeric silsesquioxane having a cage structure, at least one silicon atom may be substituted by a reactive functional group, and remaining silicon atoms that are not substituted by a reactive functional group may be substituted by unreactive functional groups.

As at least one silicon atom of the polyhedral oligomeric silsesquioxane having a cage structure is substituted by a reactive functional group, the mechanical properties of the low refractive layer and the binder resin may be improved, and furthermore, as remaining silicon atoms are substituted by unreactive functional groups, the molecular structural has steric hindrance, thus significantly lowering the frequency or probability of a siloxane bond (—Si—O—) being exposed outside, thereby improving alkali resistance of the low refractive layer and the binder resin.

The reactive functional group substituted in the polysilsesquioxane may include one or more functional groups selected from the group consisting of alcohol, amine, carboxylic acid, epoxide, imide, (meth)acrylate, nitrile, norbornene, olefin [allyl, cycloalkenyl, vinyldimethylsilyl, etc.], polyethylene glycol, thiol, and vinyl groups, and preferably, may be epoxide or (meth)acrylate.

More specific examples of the reactive functional group may include (meth)acrylate, a C1-20 alkyl (meth)acrylate, a C3-20 cycloalkyl epoxide, and a C1-10 alkyl cycloalkane epoxide. The alkyl (meth)acrylate means that another part of the “alkyl” that is not bonded to (meth)acrylate is a bonding site, the cycloalkyl epoxide means that another part of the “cycloalkyl” that is not bonded to epoxide is a bonding site, and alkyl cycloalkane epoxide means that another part of the “alkyl” that is not bonded to cycloalkane epoxide is a bonding site.

Meanwhile, the polysilsesquioxane substituted by one or more reactive functional groups may further include one or more unreactive functional groups selected from the group consisting of a C1-20 linear or branched alkyl group, a C6-20 cyclohexyl group, and a C6-20 aryl group, in addition to the above-explained reactive functional groups. As the polysilsesquioxane is substituted by a reactive functional group and an unreactive functional group on the surface, in the polysilsesquioxane substituted by one or more reactive functional groups, a siloxane bond (—Si—O—) is positioned inside of the molecule and is not exposed outside, thus further increasing alkali resistance and scratch resistance of the low refractive layer and the anti-reflective film.

Examples of the polyhedral oligomeric silsesquioxane (POSS) that is substituted by one or more reactive functional groups and has a cage structure may include: POSS substituted by one or more alcohols such as TMP diolisobutyl POSS, cyclohexanediol isobutyl POSS, 1,2-propanediolisobutyl POSS, octa(3-hydroxy-3 methyl butyldimethylsiloxy) POSS, etc.; POSS substituted by one or more amines such as aminopropylisobutyl POSS, aminopropylisooctyl POSS, aminoethylaminopropyl isobutyl POSS, N-phenylaminopropyl POSS, N-methylaminopropyl isobutyl POSS, octaammonium POSS, aminophenylcyclohexyl POSS, aminophenylisobutyl POSS, etc.; POSS substituted by one or more carboxylic acids such as maleamic acid-cyclohexyl POSS, maleamic acid-isobutyl POSS, octa maleamic acid POSS, etc.; POSS substituted by one or more epoxides such as epoxycyclohexylisobutyl POSS, epoxycyclohexyl POSS, glycidyl POSS, glycidylethyl POSS, glycidylisobutyl POSS, glycidylisooctyl POSS, etc.; POSS substituted by one or more imides such as POSS maleimide cyclohexyl, POSS maleimide isobutyl, etc.; POSS substituted by one or more (meth)acrylates such as acryloisobutyl POSS, (meth)acrylisobutyl POSS, (meth)acrylate cyclohexyl POSS, (meth)acrylate isobutyl POSS, (meth)acrylate ethyl POSS, (meth)acrylethyl POSS, (meth)acrylate isooctyl POSS, (meth)acrylisooctyl POSS, (meth)acrylphenyl POSS, (meth)acryl POSS, acrylo POSS, etc.; POSS substituted by one or more nitrile groups such as cyanopropylisobutyl POSS, etc.; POSS substituted by one or more norbornene groups such as norbornenylethylethyl POSS, norbornenylethylisobutyl POSS, norbornenylethyl disilanoisobutyl POSS, trisnorbornenyl isobutyl POSS, etc.; POSS substituted by one or more vinyl groups such as allylisobutyl POSS, monovinylisobutyl POSS, octacyclohexenyldimethylsilyl POSS, octavinyldimethylsilyl POSS, octavinyl POSS, etc.; POSS substituted by one or more olefins such as allylisobutyl POSS, monovinylisobutyl POSS, octacyclohexenyldimethylsilyl POSS, octavinyldimethylsilyl POSS, octavinyl POSS, etc.; POSS substituted by a C5-30 PEG; POSS substituted by one or more thiol groups such as mercaptopropylisobutyl POSS or mercaptopropylisooctyl POSS, etc.; and the like.

The cross-linked polymer of a photopolymerizable compound, two or more kinds of fluorine-containing compounds including photoreactive functional groups, and polysilsesquioxane substituted by one or more reactive functional groups may include, based on 100 parts by weight of the photopolymerizable compound, 0.5 to 60 parts by weight, or 1.5 to 45 parts by weight of the polysilsesquioxane substituted by one or more reactive functional groups.

If the content of the parts derived from the polysilsesquioxane substituted by one or more reactive functional groups is too small compared to the parts derived from the photopolymerizable compound in the binder resin, it may be difficult to sufficiently secure scratch resistance of the low refractive layer. Further, if the content of the parts derived from the polysilsesquioxane substituted by one or more reactive functional groups is too high compared to the parts derived from the photopolymerizable compound in the binder resin, transparency of the low refractive layer or the anti-reflective film may be deteriorated, and scratch resistance may be rather deteriorated.

Meanwhile, the photopolymerizable compound making up the binder resin may include monomers or oligomers including (meth)acrylate or vinyl groups. More specifically, the photopolymerizable compound may include monomers or oligomers including one or more, two or more, or three or more (meth)acrylate or vinyl groups.

Specific examples of the monomers or oligomers including (meth)acrylate may include pentaerythritol tri(meth)acrylate, pentaerythritol tetra(meth)acrylate, dipentaerythritol penta(meth)acrylate, dipentaerythritol hexa(meth)acrylate, tripentaerythritol hepta(meth)acrylate, thrylene diisocyanate, xylene diisocyanate, hexamethylene diisocyanate, trimethylolpropane tri(meth)acrylate, trimethylolpropane polyethoxy tri(meth)acrylate, trimethylolpropane trimethacrylate, ethylene glycol dimethacrylate, butanediol dimethacrylate, hexaethyl methacrylate, butyl methacrylate, or mixtures of two or more kinds thereof, or urethane modified acrylate oligomers, epoxide acrylate oligomers, etheracrylate oligomers, dendritic acrylate oligomers, or mixtures of two or more kinds thereof. Here, it is preferable that the molecular weight of the oligomer is 1000 to 10,000.

Specific examples of the monomers or oligomers including vinyl groups may include divinylbenzene, styrene, or paramethylstyrene.

Although the content of the part derived from the photopolymerizable compound in the binder resin is not particularly limited, considering the mechanical properties of the finally prepared low refractive layer or anti-reflective film, the content of the photopolymerizable compound may be 10 wt % to 80 wt %.

Meanwhile, the inorganic fine particles mean inorganic particles having a diameter of a nanometer or micrometer unit.

Specifically, the inorganic fine particles may include solid inorganic nanoparticles and/or hollow inorganic nanoparticles.

The solid inorganic nanoparticles mean particles that have a maximum diameter of 100 nm or less, inside of which an empty space does not exist.

The hollow inorganic nanoparticles mean particles that have a maximum diameter of 200 nm or less, on the surface and/or inside of which an empty space exists.

The solid inorganic nanoparticles may have a diameter of 0.5 nm to 100 nm, or 1 nm to 50 nm.

The hollow inorganic nanoparticles may have a diameter of 1 nm to 200 nm, or 10 nm to 100 nm.

The solid inorganic nanoparticles and the hollow inorganic nanoparticles may respectively contain one or more reactive functional groups selected from the group consisting of a (meth)acrylate group, an epoxide group, a vinyl group, and a thiol group on the surface. As the solid inorganic nanoparticles and the hollow inorganic nanoparticles respectively contain the above-explained reactive functional groups on the surfaces, the low refractive layer may have a higher cross-linking degree, thus securing more improved scratch resistance and anti-fouling properties.

As the hollow inorganic nanoparticles, particles of which surfaces are coated with a fluorine-based compound may be used alone or in combination with hollow inorganic nanoparticles of which surfaces are not coated with a fluorine-based compound. If the surfaces of the hollow inorganic nanoparticles are coated with a fluorine-based compound, surface energy may be further lowered, thereby further increasing durability or scratch resistance of the low refractive layer.

As a method of coating the surfaces of the hollow inorganic nanoparticles with a fluorine-based compound, commonly known particle coating methods or polymerization methods, etc. can be used without particular limitations, and for example, by the sol-gel reaction of the hollow inorganic nanoparticles and the fluorine-based compound in the presence of water and a catalyst, the fluorine-based compound may be bonded on the surface of the hollow inorganic nanoparticles through hydrolysis and condensation.

Specific examples of the hollow inorganic nanoparticles may include hollow silica particles. The hollow silica may include a specific functional group substituted on the surface, so as to be more easily dispersed in an organic solvent. Although examples of the organic functional groups that can be substituted on the surface of the hollow silica particles are not particularly limited, for example, a (meth)acrylate group, a vinyl group, a hydroxy group, an amine group, an allyl group, an epoxy group, a hydroxy group, an isocyanate group, an amine group, fluorine, etc. may be substituted on the surface of the hollow silica.

The binder resin of the low refractive layer may include, based on 100 parts by weight of the photopolymerizable compound, 10 to 600 parts by weight of the inorganic fine particles. If the inorganic fine particles are excessively added, due to a decrease in the content of binder, scratch resistance or abrasion resistance of the coating film may be deteriorated.

Meanwhile, the low refractive layer may be obtained by applying a photocurable coating composition including two or more kinds of fluorine-containing compounds including reactive functional groups and a photopolymerizable compound on a predetermined substrate, and photocuring it. A specific kind or thickness of the substrate is not particularly limited, and substrates known to be used for the preparation of a low refractive layer or anti-reflective film may be used without specific limitations.

As explained above, a low refractive layer obtained from a photocurable coating composition including two or more kinds of fluorine-containing compounds including photoreactive functional groups can realize low reflectance and high light transmittance, improve abrasion resistance or scratch resistance, and simultaneously secure excellent anti-fouling to external pollutants.

The low refractive layer prepared from a photocurable coating composition including two or more kinds of fluorine-containing compounds including photoreactive functional groups may have lowered interaction energy with organic materials, and thus the amount of pollutants transferred to the low refractive layer and the anti-reflective film can be significantly reduced, transferred pollutants can be prevented from remaining on the surface, and the pollutants can be easily removed.

As the photocurable coating composition for forming a low refractive layer includes two or more kinds of fluorine-containing compounds including photoreactive functional groups, a higher synergistic effect can be obtained compared to the case of using one kind of fluorine-containing compound including a photoreactive functional group, and specifically, the low refractive layer can realize more improved surface properties such anti-fouling and slip properties, etc., while securing higher physical durability and scratch resistance.

The photocurable coating composition may include, based on 100 parts by weight of the photopolymerizable compound, 20 to 300 parts by weight of the two or more kinds of fluorine-containing compounds including photoreactive functional groups. The content of the two or more kinds of fluorine-containing compounds including photoreactive functional groups with respect to the photopolymerizable compound is based on the total content of the two or more kinds of fluorine-containing compounds including photoreactive functional groups.

If the two or more kinds of fluorine-containing compounds including photoreactive functional groups are excessively added compared to the photopolymerizable compound, the low refractive layer may not have sufficient durability or scratch resistance. Further, if the content of the two or more kinds of fluorine-containing compounds including photoreactive functional groups is too small compared to the photopolymerizable compound, the low refractive layer may not have sufficient mechanical properties such as anti-fouling property or scratch resistance, etc.

The fluorine-containing compound including a photoreactive functional group may further include silicon or a silicon-containing compound. That is, the fluorine-containing compound including a photoreactive functional group may optionally contain silicon or a silicon-containing compound inside, and specifically, the content of silicon in the fluorine-containing compound including a photoreactive functional group may be 0.1 wt % to 20 wt %.

The content of silicon or a silicon-containing compound respectively included in the fluorine-containing compound including a photoreactive functional group can be confirmed through commonly known analysis methods, for example ICP [inductively coupled plasma] analysis.

The silicon included in the fluorine-containing compound including a photoreactive functional group may increase compatibility with other components included in the photocurable coating composition, and thus may prevent the generation of haze in the finally prepared low refractive layer, thereby increasing transparency, and furthermore, may improve the slip property of the surface of the finally prepared low refractive layer or anti-reflective film, thereby increasing scratch resistance.

Meanwhile, if the content of silicon in the fluorine-containing compound including a photoreactive functional group becomes too high, compatibility between the fluorine-containing compound and the other components included in the photocurable coating composition may be rather deteriorated, and thus the finally prepared low refractive layer or anti-reflective film may not have sufficient light transmittance or anti-reflective performance, and the anti-fouling property of the surface may also be deteriorated.

The photopolymerizable compound included in the photocurable coating composition may form a binder resin of the prepared low refractive layer. Specifically, the photopolymerizable compound may include monomers or oligomers including (meth)acrylate or vinyl groups. More specifically, the photopolymerizable compound may include monomers or oligomers including one or more, two or more, or three or more (meth)acrylate or vinyl groups.

Specific examples of the monomers or oligomers including (meth)acrylate may include pentaerythritol tri(meth)acrylate, pentaerythritol tetra(meth)acrylate, dipentaerythritol penta(meth)acrylate, dipentaerythritol hexa(meth)acrylate, tripentaerythritol hepta(meth)acrylate, thrylene diisocyanate, xylene diisocyanate, hexamethylene diisocyanate, trimethylolpropane tri(meth)acrylate, trimethylolpropane polyethoxy tri(meth)acrylate, trimethylolpropane trimethacrylate, ethylene glycol dimethacrylate, butanediol dimethacrylate, hexaethyl methacrylate, butyl methacrylate, or mixtures of two or more kinds thereof, or urethane modified acrylate oligomers, epoxide acrylate oligomers, etheracrylate oligomers, dendritic acrylate oligomers, or mixtures of two or more kinds thereof. Here, it is preferable that the molecular weight of the oligomer is 1000 to 10,000.

Specific examples of the monomers or oligomers including vinyl groups may include divinylbenzene, styrene, or paramethylstyrene.

Although the content of photopolymerizable compound in the photocurable coating composition is not particularly limited, considering the mechanical properties of the finally prepared low refractive layer or anti-reflective film, the content of the photopolymerizable compound in the solid content of the photocurable coating composition may be 10 wt % to 80 wt %. The solid content of the photocurable coating composition means only solid components excluding liquid components, for example, organic solvents, etc. that may be optionally included as described below, in the photocurable coating composition.

In addition, the photocurable coating composition may include polysilsesquioxane substituted by one or more reactive functional groups. The details of the polysilsesquioxane substituted by one or more reactive functional groups are as explained above.

When previously known fine particles such as silica, alumina, zeolite, etc. are used, only the strength of a film or coating is increased, while when the polysilsesquioxane substituted by one or more reactive functional groups is used, not only the strength of the finally prepared low refractive layer or anti-reflective film may be increased, but also crosslinking may be formed throughout the whole area of the film, thereby improving surface strength and scratch resistance.

More specific examples of the reactive functional group may include (meth)acrylate, a C1-20 alkyl (meth)acrylate, a C3-20 cycloalkyl epoxide, and a C1-10 alkyl cycloalkane epoxide.

The alkyl (meth)acrylate means that another part of the “alkyl” that is not bonded to (meth)acrylate is a bonding site, the cycloalkyl epoxide means that another part of the “cycloalkyl” that is not bonded to epoxide is a bonding site, and the alkyl cycloalkane epoxide means that another part of the “alkyl” that is not bonded to cycloalkane epoxide is a bonding site.

The photocurable coating composition may include, based on 100 parts by weight of the photopolymerizable compound, 0.5 to 60 parts by weight, or 1.5 to 45 parts by weight, of the polysilsesquioxane substituted by one or more reactive functional groups.

The photocurable coating composition may further include inorganic fine particles.

The inorganic fine particles mean inorganic particles having a diameter of a nanometer or micrometer unit, and specifically, the inorganic fine particles may include solid inorganic nanoparticles and/or hollow inorganic nanoparticles.

The photocurable coating composition may include, based on 100 parts by weight of the photopolymerizable compound, 10 to 600 parts by weight of the inorganic fine particles.

The details of the inorganic fine particles are as explained with regard to the low refractive layer.

The photocurable coating composition may further include a photoinitiator. Thus, in the low refractive layer prepared from the above-explained photocurable coating composition, the photopolymerization initiator may remain.

As the photopolymerization initiator, compounds known to be usable in a photocurable resin composition may be used without specific limitations, and specifically, a benzophenone-based compound, an acetophenone-based compound, a biimidazole-based compound, a triazine-based compound, an oxime-based compound, or mixture of two or more kinds thereof may be used.

The photopolymerization initiator may be used in the content of 1 to 100 parts by weight, based on 100 parts by weight of the photopolymerizable compound. If the content of the photopolymerization initiator is too small, materials that are not cured in the photocuring step and remain may be generated. If the content of the photopolymerization initiator is too high, a non-reacted initiator may remain as an impurity, and cross-linking density may be lowered to deteriorate mechanical properties of the prepared film, or reflectance may significantly increase.

The photocurable coating composition may further include an organic solvent.

Non-limiting examples of the organic solvent may include alcohols, acetates, ethers, and mixtures of two or more kinds thereof.

Specific examples of the organic solvent may include ketones such as methyl ethyl ketone, methyl isobutyl ketone, acetylacetone, isobutyl ketone, etc.; alcohols such as methanol, ethanol, n-propanol, i-propanol, n-butanol, i-butanol, t-butanol, etc.; acetates such as ethylacetate, i-propylacetate, polyethylene glycol monomethylether acetate, etc.; ethers such as tetrahydrofuran, propylene glycol monomethyl ether, etc.; or mixtures of two or more kinds thereof.

The organic solvent may be added when mixing the components included in the photocurable coating composition, or each component may be added while being dispersed in or mixed with the organic solvent. If the content of the organic solvent in the photocurable coating composition is too small, flowability of the photocurable coating composition may be deteriorated, thus generating defects such as a stripe, etc. in the finally prepared film. If the organic solvent is excessively added, the solid content may decrease, thus coating and film formation may not be sufficiently achieved, and the physical properties or surface property of the film may be deteriorated, and defects may be generated in the process of drying and curing. Thus, the photocurable coating composition may include an organic solvent such that the total solid concentration of the included components may become 1 wt % to 50 wt %, or 2 wt % to 20 wt %.

Meanwhile, for the application of the photocurable coating composition, commonly used methods and apparatuses may be used without specific limitations, and for example, bar coating such as using a Meyer bar, etc., gravure coating, 2 roll reverse coating, vacuum slot die coating, 2 roll coating, etc. may be used.

In the step of photocuring the photocurable coating composition, UV or visible light of a 200-400 nm wavelength may be irradiated, wherein the exposure amount may preferably be 100 to 4000 mJ/cm². The exposure time is not specifically limited, and may be appropriately changed according to the exposure apparatus used, the wavelength of irradiated light rays, or the exposure amount.

In the step of photocuring the photocurable coating composition, nitrogen purging, etc. may be conducted so as to apply a nitrogen atmosphere condition.

Meanwhile, as the hard coating layer, commonly known hard coating layers may be used without specific limitations.

One example of the hard coating layer may include a hard coating layer including a binder resin including a photocurable resin and organic or inorganic fine particles dispersed in the binder resin.

The photocurable resin included in the hard coating layer may be a polymer of photocurable compounds capable of inducing a polymerization reaction if light such as UV, etc. is irradiated, that is commonly known in the art. Specifically, the photocurable resin may include one or more selected from the group consisting of: reactive acrylate oligomers such as a urethane acrylate oligomer, an epoxide acrylate oligomer, a polyester acrylate, and a polyether acrylate; and multifunctional acrylate monomers such as dipentaerythritol hexaacrylate, dipentaerythritol hydroxy pentaacrylate, pentaerythritol tetraacrylate, pentaerythritol triacrylate, trimethylene propyl triacrylate, propoxylated glycerol triacrylate, trimethylpropane ethoxy triacrylate, 1,5-hexanediol acrylate, propoxylated glycerol triacrylate, tripropylene glycol diacrylate, and ethylene glycol diacrylate.

Although the particle diameter of the organic or inorganic fine particles is not specifically limited, for example, the organic fine particles may have a particle diameter of 1 μm to 10 μm, and the inorganic fine particles may have a particle diameter of 1 nm to 500 nm, or 1 nm to 300 nm. The particle diameter of the organic or inorganic fine particles may be defined as a volume average particle diameter.

Further, although specific examples of the organic or inorganic fine particles included in the hard coating film are not particularly limited, for example, the organic or inorganic fine particles may be organic fine particles selected from the group consisting of acryl-based resin particles, styrene-based resin particles, epoxide resin particles, and nylon resin particles, or inorganic fine particles selected from the group consisting of silicon oxide, titanium dioxide, indium oxide, tin oxide, zirconium oxide, and zinc oxide.

The binder resin of the hard coating layer may further include a high molecular weight (co)polymer with a weight average molecular weight of 10,000 or more.

The high molecular weight (co)polymer may be one or more selected from the group consisting of a cellulose-based polymer, an acryl-based polymer, a styrene-based polymer, an epoxide-based polymer, a nylon-based polymer, a urethane-based polymer, and a polyolefin-based polymer.

Another example of the hard coating film may include a hard coating film including a binder resin of a photocurable resin, and an antistatic agent dispersed in the binder resin.

The photocurable resin included in the hard coating layer may be a polymer of photocurable compounds capable of inducing a polymerization reaction by the irradiation of light such as UV, etc., that is commonly known in the art. However, preferably, the photocurable compound may be multifunctional (meth)acrylate-based monomers or oligomers, wherein it is advantageous in terms of securing of the properties of the hard coating layer for the number of (meth)acrylate-based functional groups to be 2 to 10, preferably 2 to 8, and more preferably 2 to 7. More preferably, the photocurable compound may be one or more selected from the group consisting of pentaerythritol tri(meth)acrylate, pentaerythritol tetra(meth)acrylate, dipentaerythritol penta(meth)acrylate, dipentaerythritol hexa(meth)acrylate, dipentaerythritol hepta(meth)acrylate, tripentaerythritol hepta(meth)acrylate, thrylene diisocyanate, xylene diisocyanate, hexamethylene diisocyanate, trimethylol propane tri(meth)acrylate, and trimethylol propane polyethoxy tri(meth)acrylate.

The antistatic agent may be a quaternary ammonium salt compound, a conductive polymer, or a mixture thereof. Here, the quaternary ammonium salt compound may be a compound having one or more quaternary ammonium salt groups in the molecule, and a low molecular type or high molecular type may be used without limitations. As the conductive polymer, a low molecular type or high molecular type may be used without limitations, and it may be one commonly used in the technical field to which the present invention pertains, and thus the kind is not specifically limited.

The hard coating film including the binder resin of the photocurable resin, and an antistatic agent dispersed in the binder resin, may further include one or more compounds selected from the group consisting of an alkoxy silane-based oligomer and a metal alkoxide-based oligomer.

Although the alkoxy silane-based compound may be one commonly used in the art, preferably, it may include one or more compounds selected form the group consisting of tetramethoxysilane, tetraethoxysilane, tetraisopropoxysilane, methyltrimethoxysilane, methyltriethoxysilane, methacryloxypropyltrimethoxysilane, glycidoxypropyltrimethoxysilane, and glycidoxypropyltriethoxysilane.

The metal alkoxide-based oligomer may be prepared by the sol-gel reaction of a composition including a metal alkoxide-based compound and water. The sol-gel reaction may be conducted by a method similar to the above-explained preparation method of the alkoxy silane-based oligomer.

However, since the metal alkoxide-based compound may rapidly react with water, the sol-gel reaction may be conducted by diluting the metal alkoxide-based compound in an organic solvent, and then slowly dripping water thereto. At this time, considering the reaction efficiency, it is preferable that the mole ratio of the metal alkoxide-based compound to water (based on metal ions) is controlled within a range of 3 to 170.

Here, the metal alkoxide-based compound may be one or more compounds selected from the group consisting of titanium tetra-isopropoxide, zirconium isopropoxide, and aluminum isopropoxide.

The anti-reflective film may further include a substrate bonded to the other side of the hard coating layer. The substrate may be a transparent film having light transmittance of 90% or more and haze of 1% or less. The substrate may be made of triacetylcellulose, a cyclo olefin polymer, polyacrylate, polycarbonate, polyethylene terephthalate, etc. The thickness of the substrate film may be 10 μm to 300 μm considering productivity, etc. However, the present invention is not limited thereto.

The low refractive layer may have a thickness of 1 nm to 200 nm, and the hard coating layer may have a thickness of 0.1 μm to 100 μm, or 1 μm to 10 μm.

### Advantageous Effects

According to the present invention, an anti-reflective film that has low reflectance and high light transmittance, that can simultaneously realize high scratch resistance and anti-fouling properties, and that can increase screen sharpness of a display device, is provided.

### DETAILED DESCRIPTION OF THE INVENTION

The present invention will be explained in the following examples in more detail. However, these examples are presented only as for illustration of the present invention, and the scope of the invention is not limited thereby.

### Preparation Example

### Preparation Example: Preparation of a Hard Coating Film

A salt-type antistatic hard coating liquid manufactured by KYOEISHA Company (solid content 50 wt %, product name: LJD-1000) was coated on a triacetyl cellulose film with a #10 Mayer bar and dried at 90° C. for 1 minute, and then irradiated by UV at 150 mJ/cm² to prepare a hard coating film with a thickness of 5 μm.

### Examples and Comparative Examples: Preparation of an Anti-Reflective Film

(1) Preparation of a Photocurable Coating Composition for Forming a Low Refractive Layer

The components of the following Table 1 were mixed, then diluted in a mixed solvent of MIBK (methyl isobutyl ketone) and diacetone alcohol (DAA) (1:1 weight ratio) such that the solid content became 3 wt %.

(2) Preparation of a Low Refractive Layer and an Anti-Reflective Film

On the above-prepared hard coating film, each photocurable coating composition for forming a low refractive layer obtained in Table 1 was coated with a #3 Mayer bar, and dried at 60° C. for 1 minute. Then, under nitrogen purging, the dried coating was irradiated by UV of 180 mJ/cm² to form a low refractive layer with a thickness of 110 nm, thus preparing an anti-reflective film.

TABLE 1

| | | | Compar- | Compar- | Compar- | Compar- | Compar- | Compar- |
|---|---|---|---|---|---|---|---|---|
| | | | ative | ative | ative | ative | ative | ative |
| | Example | Example | Example | Example | Example | Example | Example | Example |
| (unit: g) | 1 | 2 | 1 | 2 | 3 | 4 | 5 | 6 |
| THRULYA 4320 | 235 | 210 | 235 | 235 | 235 | 210 | 210 | 210 |
| X71-1203M | 125 | 85 | | | | 85 | 85 | 85 |
| OPTOOL-AR110 | | | 166.7 | | | | | |
| OPTOOL-DAC-HP | | | | 125 | | | | |
| RS90 | | | | | 250 | | | |
| RS-537 | 5 | 15 | 5 | 5 | 5 | | | |
| TU2243 | | | | | | 60 | 80 | |
| RS907 | | | | | | | | 20 |
| MA0701 | 3 | 5 | 0 | 0 | 0 | 0 | 0 | 0 |
| MIBK-ST | 33.3 | 43.3 | 33.3 | 33.3 | 33.3 | 50 | 50 | 50 |
| Dipentaerythritol | 10 | 13 | 13 | 13 | 13 | 16 | 14 | 16 |
| pentaacrylate | | | | | | | | |
| Irgacure-127 | 3 | 4 | 3 | 3 | 3 | 4 | 4 | 4 |

1) THRULYA 4320 (manufactured by Catalysts and Chemicals Co., Ltd.): a hollow silica dispersion (solid content 20 wt % in MIBK solvent)
2) X71-1203M (manufactured by Shinetsu): a fluorine-containing compound including a photoreactive functional group (diluted to the solid content of 20 wt % in MIBK solvent, fluorine content of about 45 wt % in the solid content)
3) OPTOOL-AR110 (manufactured by Daikin): a fluorine-containing compound including a photoreactive functional group (diluted to the solid content of 15 wt % in MIBK solvent, fluorine content of about 60 wt % in the solid content)
4) OPTOOL-DAC-HP (manufactured by Daikin): diluted to the solid content of 20 wt % in a mixed solvent of MIBK/MEK (1:1 weight ratio), fluorine content of about 39.5 wt % in the solid content
5) RS90 (manufactured by DIC Corporation): a fluorine-containing compound including a photoreactive functional group (diluted to the solid content of 10 wt % in bis(trifluoromethyl)benzene solvent, fluorine content of about 36.6 wt % in the solid content)
6) RS537 (manufactured by DIC Corporation): a fluorine-containing compound including a photoreactive functional group (diluted to the solid content of 40 wt % in MIBK solvent, fluorine content of about 15 wt % in the solid content)
7) TU2243 (manufactured by JSR): a fluorine-containing compound including a photoreactive functional group (diluted to the solid content of 10 wt % in MIBK solvent, fluorine content of about 13 wt % in the solid content)
8) RS907 (manufactured by DIC Corporation): a fluorine-containing compound including a photoreactive functional group (diluted to the solid content of 30 wt % in MIBK solvent, fluorine content of about 17 wt % in the solid content)
9) MA0701: polysilsesquioxane (manufactured by Hybrid Plastics)
10) MIBK-ST (manufactured by Nissan Chemical Industries, Ltd.): nanosilica dispersion, diluted to the solid content of 30 wt % in MIBK solvent

### Experimental Example: Measurement of the Properties of Anti-Reflective Films

For the anti-reflective films obtained in the examples and comparative examples, the following experiments were conducted.

1. Measurement of Mean Reflectance

One side of the above prepared anti-reflective film was darkened, and then mean reflectance at a wavelength region of 380 nm to 780 nm was measured using Solidspec 3700 (SHIMADZU) applying a measure mode.

2. Measurement of Scratch Resistance

While steel wool was loaded and allowed to go back and forth 10 times at 27 rpm, the surfaces of the anti-reflective films obtained in the examples and comparative examples were rubbed. The maximum load under which one or fewer scratches of 1 cm or less was observed with the unaided eye was measured.

3. Evaluation of Anti-Fouling Property

On the surface of the anti-reflective films obtained in the examples and comparative examples, straight lines were drawn with a black oil-based pen and rubbed with a clean wiper, and the number of rubs at which the lines were erased was confirmed to measure anti-fouling properties.

⊚: Erased at less than 5 rubs

0: Erased at 5 to 10 rubs

Δ: Erased at 11 to 20 rubs

X: Erased at 21 or more rubs, or not erased

4. Measurement of Haze

For the anti-reflective films respectively obtained in the examples and comparative examples, the total haze of 3 spots was measured according to JIS K7105, and the mean value was calculated.

TABLE 2

| | | | Compar- | Compar- | Compar- | Compar- | Compar- | Compar- |
|---|---|---|---|---|---|---|---|---|
| | | | ative | ative | ative | ative | ative | ative |
| | Example | Example | Example | Example | Example | Example | Example | Example |
| | 1 | 2 | 1 | 2 | 3 | 4 | 5 | 6 |
| Haze (%) | 0.2 | 0.2 | 0.8 | 0.7 | 0.8 | 0.3 | 0.5 | 0.6 |
| ean reflectance (%) | 0.54 | 0.69 | 0.53 | 0.6 | 0.6 | 0.74 | 0.7 | 0.7 |
| Scratch | 400 | 500 | 250 | 250 | 200 | 300 | 250 | 300 |
| resistance (g) | | | | | | | | |
| Anti-fouling | ⊚ | ⊚ | Δ | X | X | 0 | 0 | 0 |

As shown in Table 2, it was confirmed that the anti-reflective films of the examples exhibit low reflectance of 0.7% or less and low total haze values of 0.25% or less, and thus exhibit relatively high light transmittance and excellent optical properties, and furthermore, have high scratch resistance and excellent anti-fouling properties.

To the contrary, it was confirmed that although the anti-reflective films of the comparative examples have mean reflectances equivalent to that of the examples, they exhibit relatively high total haze value and relatively inferior scratch resistance and anti-fouling properties.

1. An anti-reflective film comprising:
a hard coating layer
and
a low refractive layer which comprises a binder resin comprising a cross-linked polymer of a photopolymerizable compound, two or more kinds of fluorine-containing compounds comprising photoreactive functional groups, and polysilsesquioxane substituted by one or more reactive functional groups; and inorganic fine particles dispersed in the binder resin.

2. The anti-reflective film according to claim 1,
wherein total haze of the anti-reflective film is 0.45% or less.

3. The anti-reflective film according to claim 1,
wherein the two or more kinds of fluorine-containing compounds comprising photoreactive functional groups have different fluorine contents according to the kind.

4. The anti-reflective film according to claim 1,
wherein the two or more kinds of fluorine-containing compounds comprising photoreactive functional groups comprise a first fluorine-containing compound comprising a photoreactive functional group and comprising 25 wt % to 60 wt % of fluorine.

5. The anti-reflective film according to claim 4,
wherein the two or more kinds of fluorine-containing compounds comprising photoreactive functional groups comprise a second fluorine-containing compound comprising a photoreactive functional group and comprising fluorine in a content of 1 wt % or more and less than 25 wt %.

6. The anti-reflective film according to claim 5,
wherein a difference between the first fluorine-containing compound and the second-fluorine containing compound is 5 wt % or more.

7. The anti-reflective film according to claim 5,
wherein a weight ratio of the second fluorine-containing compound to the first fluorine-containing compound is 0.01 to 0.5.

8. The anti-reflective film according to claim 1,
wherein the cross-linked polymer comprises 20 to 300 parts by weight of the two or more kinds of fluorine-containing compounds comprising photoreactive functional groups, based on 100 parts by weight of the photopolymerizable compound.

9. The anti-reflective film according to claim 1,
wherein the fluorine-containing compounds comprising photoreactive functional groups include one or more selected from the group consisting of: i) aliphatic compounds or alicyclic compounds substituted by one or more photoreactive functional groups, in which at least one carbon atom is substituted by one or more fluorine atoms; ii) heteroaliphatic compounds or heteroalicyclic compounds substituted by one or more photoreactive functional groups, in which at least one hydrogen is substituted by fluorine and at least one carbon is substituted by silicon; iii) a polydialkyl siloxane-based polymer substituted by one or more photoreactive functional groups, in which at least one silicon is substituted by one or more fluorines; and iv) polyether compounds substituted by one or more photoreactive functional groups, in which at least one hydrogen is substituted by fluorine.

10. (canceled)

11. The anti-reflective film according to claim 1,
wherein the cross-linked polymer of a photopolymerizable compound, two or more kinds of fluorine-containing compounds comprising photoreactive functional groups, and polysilsesquioxane substituted by one or more reactive functional groups comprises 0.5 to 60 parts by weight of the polysilsesquioxane substituted by one or more reactive functional groups based on 100 parts by weight of the photopolymerizable compound.

12. The anti-reflective film according to claim 1,
wherein the reactive functional group substituted with polysilsesquioxane includes one or more functional groups selected from the group consisting of alcohol, amine, carboxylic acid, epoxide, imide, (meth)acrylate, nitrile, norbornene, olefin, polyethylene glycol, thiol, and vinyl groups.

13. The anti-reflective film according to claim 11,
wherein the polysilsesquioxane substituted by one or more reactive functional groups is further substituted by one or more unreactive functional groups selected from the group consisting of a C1-20 linear or branched alkyl group, a C6-20 cyclohexyl group, and a C6-20 aryl group.

14. The anti-reflective film according to claim 1,
wherein the polysilsesquioxane substituted by one or more reactive functional groups includes polyhedral oligomeric silsesquioxane that is substituted by one or more reactive functional groups and has a cage structure.

15. The anti-reflective film according to claim 14,
wherein in the polyhedral oligomeric silsesquioxane having a cage structure, at least one silicon is substituted by a reactive functional group and remaining silicons that are not substituted by a reactive functional group are substituted by an unreactive functional group.

16. The anti-reflective film according to claim 1,
wherein the inorganic fine particles include one or more kinds selected from the group consisting of solid inorganic nanoparticles having a diameter of 0.5 nm to 100 nm and hollow inorganic nanoparticles having a diameter of 1 nm to 200 nm.
